(19) United States
(12) Patent Application Publication
(10) Pub. No.: US 2008/0192735 A1
(43) Pub. Date: Aug. 14, 2008

(54) Multi-Function Bluetooth VOIP System

(75) Inventor: Ming-Chia HUANG, Hsinchu (TW)

Correspondence Address: WPAT, PC;INTELLECTUAL PROPERTY ATTORNEYS, 2030 MAIN STREET, SUITE 1300, IRVINE, CA, 92614, US

(73) Assignee: MKD TECHNOLOGY INC., Hsinchu (TW)

(21) Appl. No.: 12/026,542

(22) Filed: Feb. 5, 2008

(30) Foreign Application Priority Data
Feb. 9, 2007 (TW) 96202577

(51) Int. Cl. H04L 12/66

(52) U.S. Cl. 370/352

(57) ABSTRACT

A multi-function Bluetooth® VoIP apparatus is adapted for conducting a talk over network with a network-accessible host. The multi-function Bluetooth® VoIP apparatus includes a memory module, a Bluetooth® module, a USB module, and a control module. In operation, the USB module is inserted into a USB port of the host. Then the control module logs in a VoIP system via a VoIP software program with a username and a password read from the memory module. Then, the Bluetooth® module transmits voice signals from a subscriber, who is calling or being called, via the VoIP system to a Bluetooth® wireless communication device. Also, the Bluetooth® module transmits voice signals from the Bluetooth® wireless communication device via the VoIP system to the subscriber.

### BACKGROUND OF THE INVENTION

1. Field of the Invention

The present invention relates generally to a voice over internet protocol (VoIP) apparatus, and more particularly, to a multi-function Bluetooth® VoIP apparatus adapted for talking over network.

2. The Prior Arts

Because of the progress of the VoIP technology, such as Skype®, the voice quality of a current VoIP system is almost as good as that of a conventional telephone. Therefore, more and more people turn to use VoIP as a choice for voice communication. However, the VoIP system uses a personal computer (PC) for network operation. As such, it hinders further popularization of the VoIP systems in the market. As a solution, many VoIP apparatus manufacturers provide Bluetooth® wireless communication systems to work with VoIP apparatus.

A typical Bluetooth® VoIP apparatus includes a USB interface. After the USB interface is inserted into a USB port of a PC, a driver program corresponding to the Bluetooth® VoIP apparatus is automatically installed. Then, the user himself may install a VoIP software program, e.g., Skype®. In such a way, when other Skype® subscribers call, a built-in ringer module of a Bluetooth® wireless communication device will ring to show there is an incoming call. The user can then pressed the talk button to talk with the caller just like using a conventional wireless phone.

The USB interface is equipped with a PnP (plug-and-play) feature that allows the Bluetooth® VoIP apparatus to automatically install the driver program. However, the Bluetooth® VoIP apparatus still needs corresponding VoIP software to log in a VoIP system to conduct a talk over network. Further, a conventional Bluetooth® VoIP apparatus needs the use to setup and operate the VoIP software program on the personal computer. For example, the user has to run the VoIP software program and enter a username and a password to log in the VoIP system. If the VoIP software program is not installed on the computer, the user has to obtain and install the VoIP software program. Therefore, it is difficult to overcome usability barriers of the conventional Bluetooth® VoIP apparatus for those who are not familiar with the PC.

### SUMMARY OF THE INVENTION

A primary objective of the present invention is to provide a multi-function Bluetooth® VoIP apparatus including a control module and a built-in VoIP software program. The control module installs the VoIP software program to a host, such as a PC, which does not have VoIP function before installation. After installation of the VoIP software program, the multi-function Bluetooth® VoIP apparatus allows a user to conduct a VoIP talk by a Bluetooth® wireless communication device.

Another objective of the present invention is to provide a multi-function Bluetooth® VoIP apparatus including a memory module that stores a VoIP software program, a username and a password. The control module allows a host to further store/retrieve data to/from the memory module, respectively. Thus, the multi-function Bluetooth® VoIP apparatus can also work like a memory stick.

A further objective of the present invention is to provide a multi-function Bluetooth® VoIP apparatus having secure encryption feature. The multi-function Bluetooth® VoIP apparatus is controlled by a control module and provides a corresponding security treatment, such as fingerprint identification, RFID, 128 bits encryption & authentication to the username, password, and ordinary data (as a memory stick).

In order to achieve the objectives mentioned above, a multi-function Bluetooth® VoIP apparatus according to the present invention includes a memory module, a Bluetooth® module, a USB module, and a control module. The multi-function Bluetooth® VoIP apparatus is adapted for conducting a talk over network via a VoIP system of a network-accessible host. In operation, a USB interface of the USB module is inserted into a USB port of the host. Then the control module logs in the VoIP system via a VoIP software program with a username and a password read from a memory unit. Then, the Bluetooth® module transmits voice signals from a subscriber, who is calling or being called, via the VoIP system to a Bluetooth® wireless communication device. Also, the Bluetooth® module transmits voice signals from the Bluetooth® wireless communication device via the VoIP system to the subscriber.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating a multi-function Bluetooth® VoIP apparatus according to the present invention; and

FIG. 2 is a flow chart illustrating the operation of the multi-function Bluetooth® VoIP apparatus according to the present invention.

### DETAILED DESCRIPTION OF THE PREFERRED EMBODIMENT

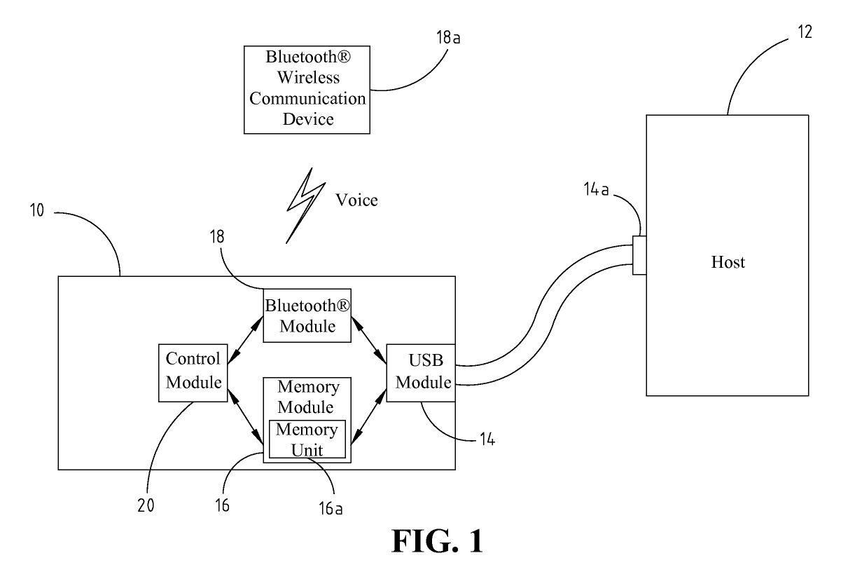

Referring to FIG. 1, a multi-function Bluetooth® VoIP apparatus 10 according to the present invention includes a USB module 14 having a USB interface 14a, a memory module 16 having a memory unit 16a, a Bluetooth® module 18, and a control module 20. The memory module 16 is adapted for storing a VoIP software program and a username and a password for logging in the VoIP software program. The Bluetooth® module 18 is adapted for connecting with a Bluetooth® wireless communication device 18a by Bluetooth® wireless communication. After the USB interface 14a of the USB module 14 is inserted into a USB port (not shown) of a host 12, the USB module 14 is adapted to transmit data to and from the host 12 via the USB interface 14a. The USB module 14 is electrically connected to the memory module 16 and the Bluetooth® module 18, respectively. The Bluetooth® wireless communication device 18a has a receiver unit and/or an emitter unit. That is, the Bluetooth® wireless communication device 18a has at least an earphone, a microphone, and an earphone/microphone set for transmitting voice with the Bluetooth® module 18. The host 12 may be a personal computer (PC).

In order to allow the host 12, which is accessible to a network but is not equipped with VoIP function, to be capable of conducting a VoIP talk, the multi-function Bluetooth® VoIP apparatus 10 according to the present invention has the USB interface 14a inserted into the USB port of the host 12. After the insertion of the USB interface 14a, a driver program is installed just like a regular USB apparatus. Moreover, the control module 20 retrieves the VoIP software program from the memory unit 16a. The retrieved VoIP software program is transmitted to the host 12 via the USB module 14 and installed in the host 12 after confirmed by the user. Then, upon a completion of the installation, the username and password stored in the memory unit 16a are used for logging in the VoIP system via the VoIP software program. In such a way, the user is capable of conducting a talk over network by the Bluetooth® wireless communication device 18a, which is controlled by the Bluetooth® module 18.

Further, the memory module 16 which is originally used for storing the VoIP software program, the username, and the password, can also be controlled by the control module 20 to allow the host 12 to store/retrieve data thereto or therefrom. In such a way, the multi-function Bluetooth® VoIP apparatus 10 can also serve as a memory stick. In addition to the voice communication, the multi-function Bluetooth® VoIP apparatus 10 is also capable of exchanging data wirelessly with hardware (such as an audio card, a wireless mouse, a wireless keyboard, etc.) having a Bluetooth® apparatus by the memory module 16 and the Bluetooth® module 18. In the case of the Bluetooth® audio card, the multi-function Bluetooth® VoIP apparatus 10 further includes a plug and play USB audio function. Thus, the multi-function Bluetooth® VoIP apparatus 10 can be identified as a Bluetooth® audio card when inserted into the USB port of the host 12.

In order to protect the data (especially the username and the password) stored in the memory unit 16a, the multi-function Bluetooth® VoIP apparatus 10 can be controlled by the control module 20 to provide a corresponding security treatment, such as fingerprint identification, RFID, 128 bits encryption, in accordance with a store/retrieve demand to either a username/password, or ordinary data (as a memory stick). The memory unit 16a of the memory module 16 may have a plurality of VoIP software programs, such as Skype®, MSN® messenger, and Yahoo® messenger. In this situation, the control module 20 provides a selection list shown on a display (not shown) of the host 12 or a display (not shown) built-in the multi-function Bluetooth® VoIP apparatus 10. Then, the user can select at least one of the VoIP software program to install or update.

A principle of operation of the VoIP software program to conduct a talk over network with the host 12 which is accessible to the network is to be briefly discussed below. After the USB interface 14a is inserted into the USB port of the host 12, the control module 20 logs in the VoIP system with the username and password read from the memory module 16 by the VoIP software program, then designates a subscriber to be called or being calling by the VoIP software program, and then waits for completing a connection. After the connection, the Bluetooth® module 18 transmits voice signals of the subscriber from the VoIP system to the Bluetooth® wireless communication device 18a, and meanwhile, the Bluetooth® module 18 transmits voice signals from the Bluetooth® wireless communication device 18a through the VoIP system to the subscriber.

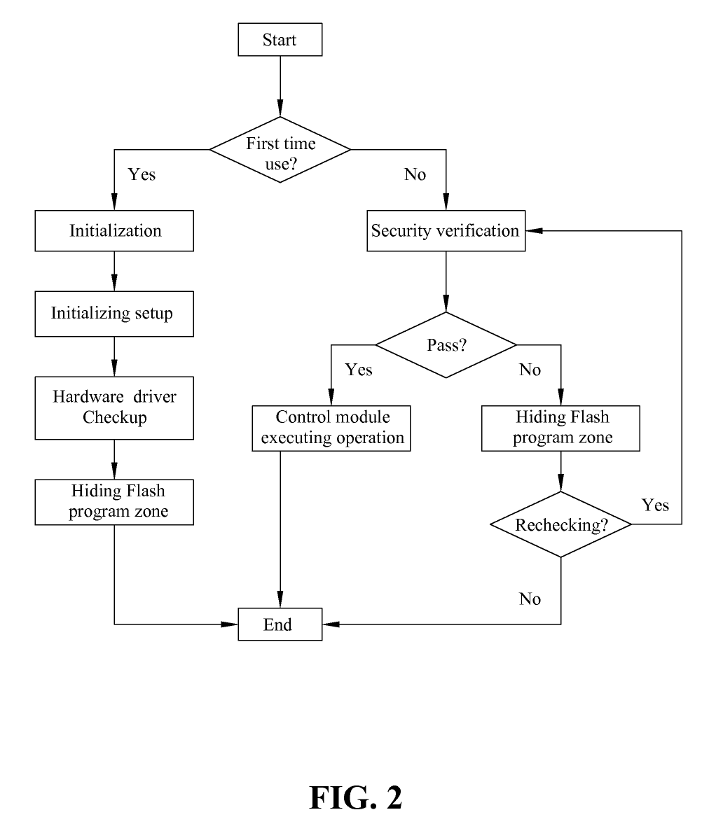

FIG. 2 is a flow chart illustrating the operation of the multi-function Bluetooth® VoIP apparatus according to the present invention. Referring to FIG. 2, when the USB interface 14a is inserted into the USB port of the host 12, the multi-function Bluetooth® VoIP apparatus is checked whether it is first time use in the host 12. If it is first time use of the multi-function Bluetooth® VoIP apparatus, an initialization and an initializing setup are conducted to the multi-function Bluetooth® VoIP apparatus. Thereafter, a hardware driver checkup is performed to detect whether the driver programs of a USB HUB (the USB module 14) and the Bluetooth® module 18 have been properly installed. If the driver programs do not exist, the driver programs are installed. After that, a software checkup is conducted, which is controlled by the control module 20. The control module 20 conducts security verification, executes installation and setup of the software, and then updates the software if needed. The security verification is provided for protecting the username and the password. When the security verification is conducted first time, it requires entering a username and a password. The entered username and the password are then conducted with a 128 bit encryption. Therefore, in the future, only when being verified, the username and the password stored in the memory unit 16a can be accessed.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A multi-function Bluetooth® voice over internet protocol (VoIP) apparatus, adapted for conducting a talk over a network with a host capable of accessing the network and via a VoIP system, the host has a VoIP software program of the VoIP system, which has been installed in the host, to log in the VoIP system, the multi-function Bluetooth® VoIP apparatus comprising:
a memory module, comprising a memory unit, being adapted for storing a username and a password for logging in the VoIP software program;
a Bluetooth® module, adapted for connecting with a Bluetooth® wireless communication device by Bluetooth® wireless communication.
a USB module, comprising a USB interface, wherein when the USB interface is inserted into a USB port of the host, data can be transmitted between the USB interface and the host, the USB module being electrically connected to the memory module and the Bluetooth® module, respectively; and
a control module, wherein after the USB interface is inserted into the USB port of the host, the control module logs in the VoIP system via the VoIP software program with the username and the password read from the memory unit, and wherein the Bluetooth® module transmits voice signals from a subscriber, who is calling or being called, via the VoIP system, to the Bluetooth® wireless communication device, and transmits voice signals from the Bluetooth® wireless communication device via the VoIP system, to the subscriber.

2. The multi-function Bluetooth® VoIP apparatus according to claim 1, wherein the control module conducts a security treatment to the username and the password in accordance with a store/retrieve demand thereto.

3. The multi-function Bluetooth® VoIP apparatus according to claim 1, wherein the control module is adapted to store and retrieve data to and from the memory unit of the memory module according to a store and retrieve command coming from the host, respectively.

4. The multi-function Bluetooth® VoIP apparatus according to claim 1, wherein when there are a plurality of VoIP software programs stored in the memory unit of the memory module, the control module allows a user to select at least one of the VoIP software programs to install/update.

5. The multi-function Bluetooth® VoIP apparatus according to claim 1, wherein the Bluetooth® wireless communication device comprises at least one of a Bluetooth® microphone and a Bluetooth® earphone.
